(19) United States
(12) Patent Application Publication
(10) Pub. No.: US 2009/0089304 A1
(43) Pub. Date: Apr. 2, 2009

(54) System and Method for Configuration of Revenue Analysis Grids

(76) Inventor: Mark Kopcha, Atlanta, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/240,345

(22) Filed: Sep. 29, 2008

Related U.S. Application Data
(60) Provisional application No. 60/975,965, filed on Sep. 28, 2007.

(51) Int. Cl. G06F 17/30

(52) U.S. Cl. 707/100; 707/E17.005

(57) ABSTRACT

A system and method for configuring and maintaining grids to analyze their revenue relationships in order to better determine where to invest time and resources. Analysis grids can be quickly and easily tailored to adjust to the unique needs of an organization.

### CROSS-REFERENCE TO RELATED APPLICATIONS

This application claims priority to U.S. provisional application No. 60/975,965, filed Sep. 28, 2007, which is incorporated herein by reference.

### BACKGROUND OF THE INVENTION

A system and method for configuring and maintaining analysis grids is described herein.

Corporations and other business or non-profit entities are often in need of a method for analyzing their revenue relationships with customers, clients, partners, suppliers, dealers, distributors, resellers, agencies, managers, or other persons or entities (“Accounts”) with whom the corporation does business or seeks to do business. Analysis grids are used to help individuals and teams better determine where to invest their time and resources. Such grids may include peer-to-peer comparisons based on criteria such as past performance and future potential, for example.

Traditionally, companies that have developed analysis grids have utilized standard spreadsheet software and/or have customized software programs such as customer relationship management (“CRM”) software. Such methods have the drawback, however, that they are hard coded and therefore very difficult to quickly or easily configure and adjust when necessary.

For instance, many companies have traditionally used spreadsheets to create their analysis grids. Such documents are often edited to tailor a standardized grid to a particular set of Accounts. This editing may take place in an ad-hoc and uncontrolled fashion as information is changed to meet the needs of the relationships with the given set of Accounts. Such uncontrolled editing can quickly lead to a plethora of grids, each with non-standard terms that cannot be easily edited or reviewed for correctness. Further, group managers cannot easily view a consolidated view of Accounts across their team.

### SUMMARY OF THE INVENTION

A system and method for configuring and maintaining grids to analyze revenue relationships is described herein. This is accomplished through the use of a configurable software application that allows grids and grid criteria to be dynamically created and maintained. The grids are then used for peer-to-peer comparison or group analysis allowing end-users to better determine where to invest their time and resources.

The system and method described herein is a dynamic, database-driven solution that allows analysis grids to be rapidly customized to suit the individual needs of end-users dealing with different Accounts, Partners, or Opportunities. Such a database-driven system obviates the need for business analysts or others to customize or update word-processed documents, spreadsheets, or any other paper-based analysis grids to meet the different needs of end-users. Further, the database-driven system also obviates the need for software developers or other analysts to customize or hard-code software modules or computer code (including CRM screens and software) or any other electronic analysis grid implementations to meet the different needs of end-users. Rather, a system administrator can simply create, update, or delete data in a centralized database which will cause the dynamic updating of the analysis grid templates that incorporate such data. This dynamic updating will occur without any software modifications or configuration. End-users can then use such updated grid templates to meet their business needs.

### BRIEF DESCRIPTION OF THE DRAWINGS

FIG. 1 is a diagram of a system in an exemplary embodiment.

FIG. 2 is a flow diagram illustrating the steps whereby a system administrator can manage the data stored on the enterprise server in one embodiment.

FIG. 3 is a Grid List screen in an exemplary embodiment.

FIG. 4 is a Grid Detail screen in an exemplary embodiment.

FIG. 5 is the top part of a Grid Detail with Axis Detail screen in an exemplary embodiment.

FIG. 5A is the bottom part of a Grid Detail with Axis Detail screen in an exemplary embodiment.

FIG. 6 is a Grid Criteria Detail screen in an exemplary embodiment.

FIG. 7 is a Grid Preview screen in an exemplary embodiment.

FIG. 8 is a flow diagram illustrating the steps whereby a system administrator can assign configured grids to defined groups.

FIG. 9 is a User Group Detail screen in an exemplary embodiment.

FIG. 10 is a flow diagram illustrating the steps whereby an end-user can edit and utilize grids in one embodiment.

FIG. 11 is a Grid Display screen in an exemplary embodiment.

FIG. 12 is a Grid Data screen in an exemplary embodiment.

FIG. 13 is a Group Summary screen in an exemplary embodiment.

FIG. 14 is a Manual Ranking screen in an exemplary embodiment.

### DETAILED DESCRIPTION

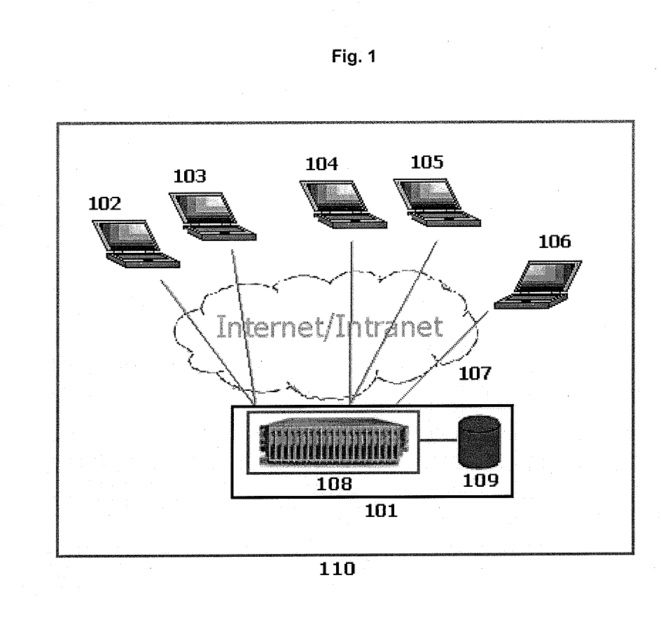

FIG. 1 is a system diagram of an exemplary embodiment of a system 110 for configuring and maintaining analysis grids. Users can access the enterprise server 101 through one or more clients 102-106. Clients 102-106 communicate with enterprise server 101 over network 107. Network 107 is a private network such as a local area network in some embodiments. In other embodiments, network 107 is a public network such as the public internet. Clients 102-106 provide users with a user interface to access and control the enterprise server 101. It is to be understood that the five clients of FIG. 1 are for illustration purposes only and not intended to limit the scope of the invention. The enterprise server 101 maintains the business logic for processing and storing the various grids, grid templates, grid axis criteria, responses, scores, rankings, and attendant data. The business logic contains rules for managing the information contained in the various grids, grid templates, grid axis criteria, responses, scores, rankings, and attendant data. The enterprise server 101 comprises at least one programmable control unit 108 having an executable program therein for executing the business logic. The enterprise server 101 further comprises a database 109 for saving data, as discussed herein. The database 109 may or may not be located nearby the programmable control unit 108. That is, the enterprise server 101 may be distributed with a programmable control unit 108 in one location and a database 109 in a remote location.

The clients 102-106 are configured based on the type of user that uses a particular client. Some clients are configured to allow a system administrator to manage and configure the data stored on the enterprise server 101. Other clients are configured to allow end-users to utilize the data stored on the enterprise server 101 and manipulate said data according to their business needs.

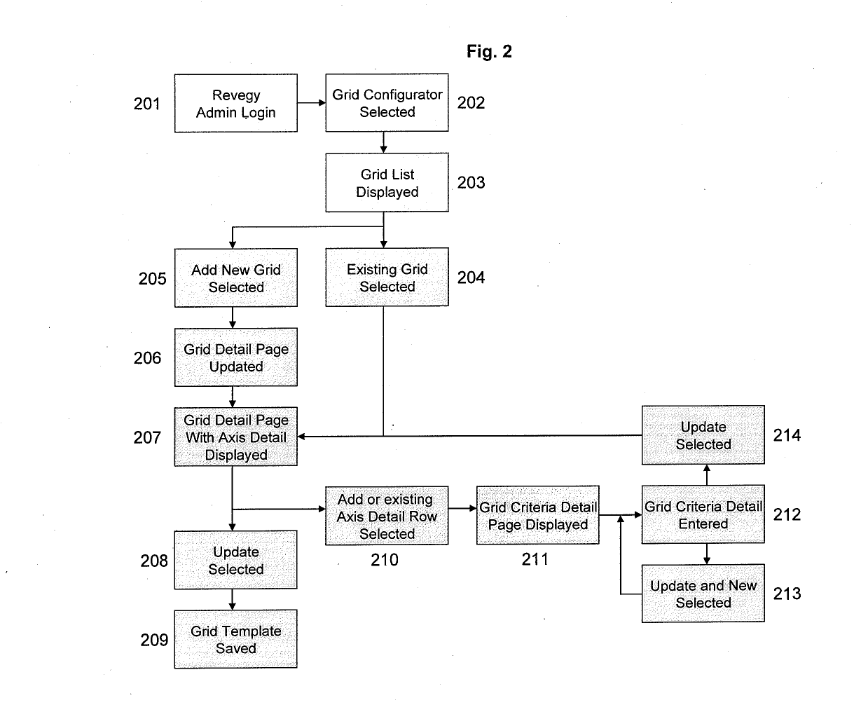

FIG. 2 is a flow diagram illustrating the steps whereby a system administrator (“Admin”) can create, manage, and store grid templates on the enterprise server 101 in one embodiment. The Admin can access the enterprise server 101 via client 106, for example.

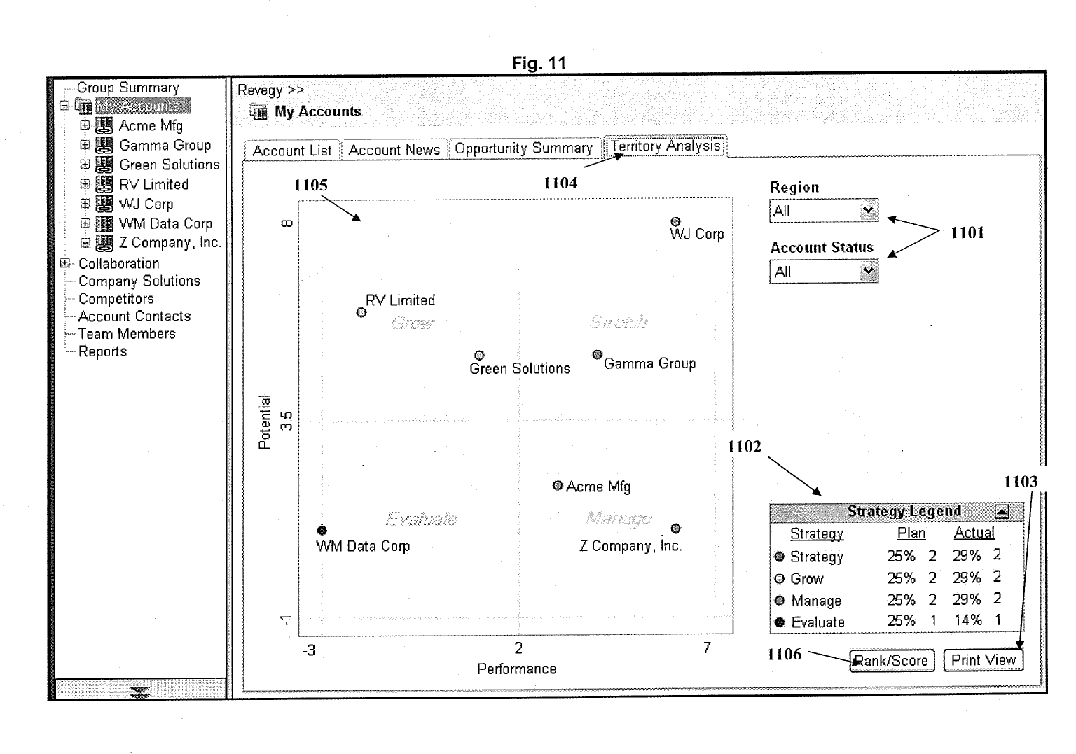

Grid templates are analysis grids that can be easily filled in by an end-user for a particular Account, Partner, or Opportunity to create a means for scoring such things as the performance or potential of a company and for viewing peer-to-peer comparisons. FIG. 11 shows an analysis grid 1105 in an exemplary embodiment. Analysis grid templates can contain such things as performance measurements on the x-axis and measurements of future potential on the y-axis. That is, a performance score or ranking can be plotted on the x-axis showing the current performance of a given company. A score or ranking for the potential (future) performance of the same company can be plotted on the y-axis. Thus, a single company can be plotted on the analysis grid 1105 based on its (performance, potential) coordinate, visually illustrating how the company is currently performing and how it may perform in the future. The end-user can, in turn, use the data on the analysis grid 1105 to determine which Accounts, Partners, or Opportunities to focus on first or how to best manage each.

For instance, a company with a high performance score and a high potential score is one which is performing well now and is expected to continue performing well. Such a company would appear in the upper right quadrant of an analysis grid. The upper left quadrant of the grid would contain (growing) companies with low current performance but expected high future performance (potential). Companies with a high current performance but low future potential would correspond to businesses in a steady-state or in decline and would fall in the lower right quadrant. Finally, companies with poor current performance and expected poor future performance would lie in the lower left quadrant of the grid.

Grid templates are sample analysis grids that can be easily tailored by an end-user for a particular Account, Partner, or Opportunity to create a customized analysis grid for that Account, Partner, or Opportunity. System administrators configure and maintain grid templates. End-users customize grid templates to meet their specific needs in dealing with a specific Account, Partner, or Opportunity.

Typically, an Admin will configure the x-axis and y-axis criteria (questions) so as to prompt an end-user to respond to the criteria. As described above, the x-axis criteria may relate to the current performance of a company while the y-axis criteria relate to the potential future performance of the company. The Admin will name each axis to correspond to the type of criteria associated with that axis. For instance, the x-axis can be named “Performance” to indicate that the x-axis contains criteria related to performance. Likewise, the y-axis can be named “Potential” to indicate that the y-axis contains criteria related to potential. Examples of criteria, by way of illustration and not limitation, include revenue, market share, number of employees, number of companies, annual IT spend, annual growth rate, relationship level, revenue, revenue potential, current status as a customer, and satisfaction with current vendors.

When creating a customized analysis grid based on such a grid template, an end-user will enter data (or choose a selection from a drop-down box) in response to such criteria (questions). For instance, an end-user might indicate that a given company's current annual IT spend is between $1.5 and $2 million in response to the annual IT spend criteria. Such a response would then be used (in part) to calculate the company's performance score which would then be plotted along the x-axis. In response to a revenue potential criteria, the end-user might respond that the company has a potential revenue of $10 million. Such a response would then be used (in part) to calculate the company's potential (future) performance score which would be plotted along the y-axis.

Alternative embodiments can have different types of criteria for the x- and y-axes. As explained above, the Admin will name each axis to correspond to the criteria type for that axis. In one embodiment, for example, the x-axis represents revenue and the y-axis represents risk. This embodiment can be used to measure the revenue generated by an Account against the risk that the Account will not renew its maintenance or subscription agreement. In another embodiment, the x-axis represents Opportunity revenue and the y-axis represents Opportunity quality. In some embodiments, the Admin can dynamically configure the criteria.

In some embodiments, the Admin can create different criteria and criteria types for different grid templates. That is, different grid templates do not need to have the same criteria or the same type of criteria. For instance, one grid template could have an x-axis criteria type of Performance and a y-axis criteria type of Potential along with a plurality of criteria for each of the two axes. A second grid template could have an x-axis criteria type of Revenue and a y-axis criteria type of Risk along with a plurality of criteria for each axis. The aforementioned examples of criteria and criteria types are by way of illustration only and are not intended to limit the number or type of criteria that may be defined by an Admin.

Returning to FIG. 2, at step 201, the Admin logs into the system 110. Such authentication can be by username and password or other suitable methods. Such methods for authenticating users are well known to those with skill in the art.

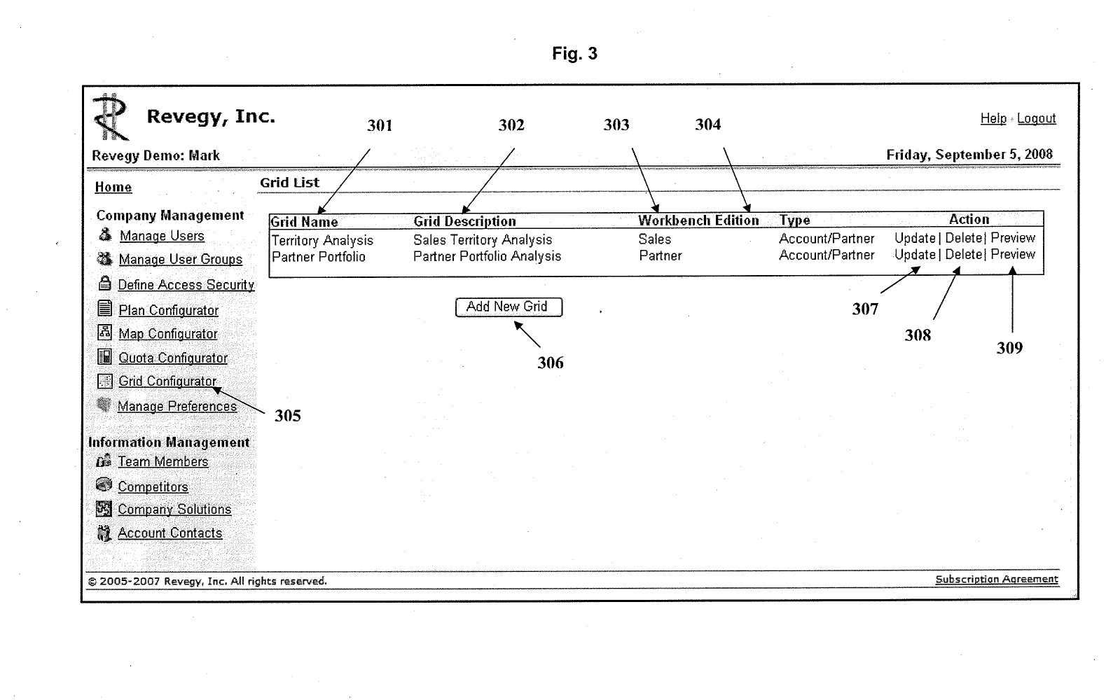

After logging in, the Admin will be presented with a welcome screen. In step 202, the Admin selects Grid Configurator link 305 (FIG. 3) to access the Grid Configurator module. The Grid Configurator module is the software module that allows the Admin to create, update, and delete analysis grid templates and their attendant grid criteria questions.

Upon entering the Grid Configurator module, the Admin is presented with the Grid List screen (FIG. 2 step 203), as shown in FIG. 3. The Grid List screen displays all the grid templates that have been created and stored in the enterprise server 101. This screen shows fields for the Grid Name 301, Grid Description 302, Workbench Edition 303, and Type 304 for each grid template. The Grid Name 301 field contains the Admin-defined name for a particular grid template. The Grid Description 302 field contains a description of the grid template, also created by the Admin. The Grid Type 304 field describes the type of the grid template.

Typical values for Grid Type 304 are AccountPartner and Opportunity. An “AccountPartner” Grid Type denotes a grid template that is suitable for existing Accounts or Partners such as existing clients, customers, or partners. An “Opportunity” Grid Type denotes a grid template that is suitable for prospective Accounts or Partners; that is, an Opportunity is a person or entity that the business is seeking out as a client, customer, or partner.

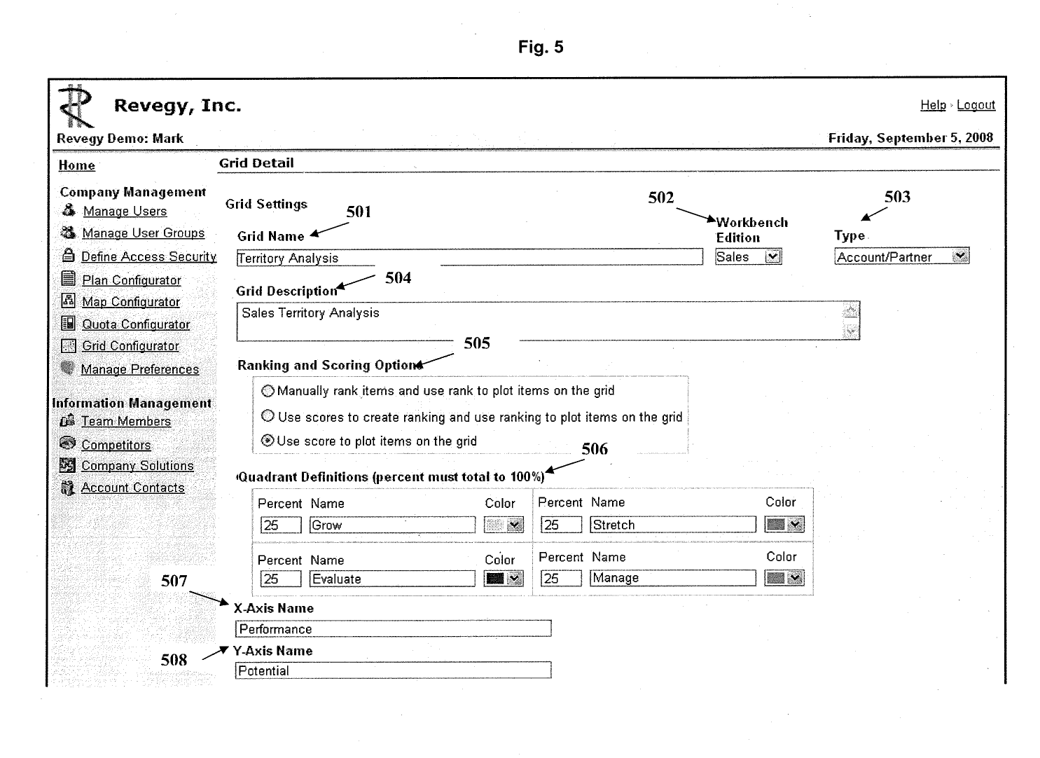

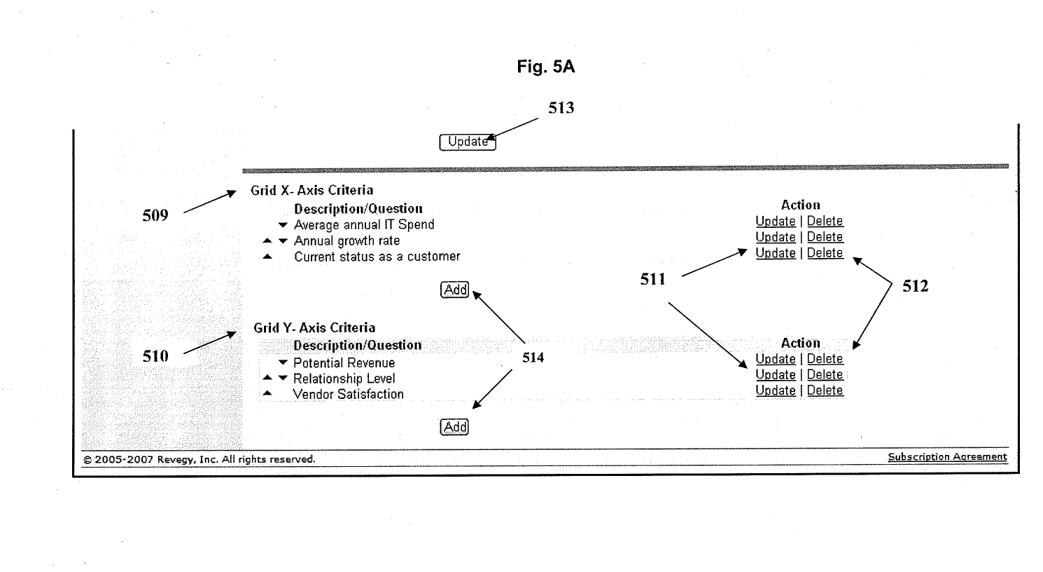

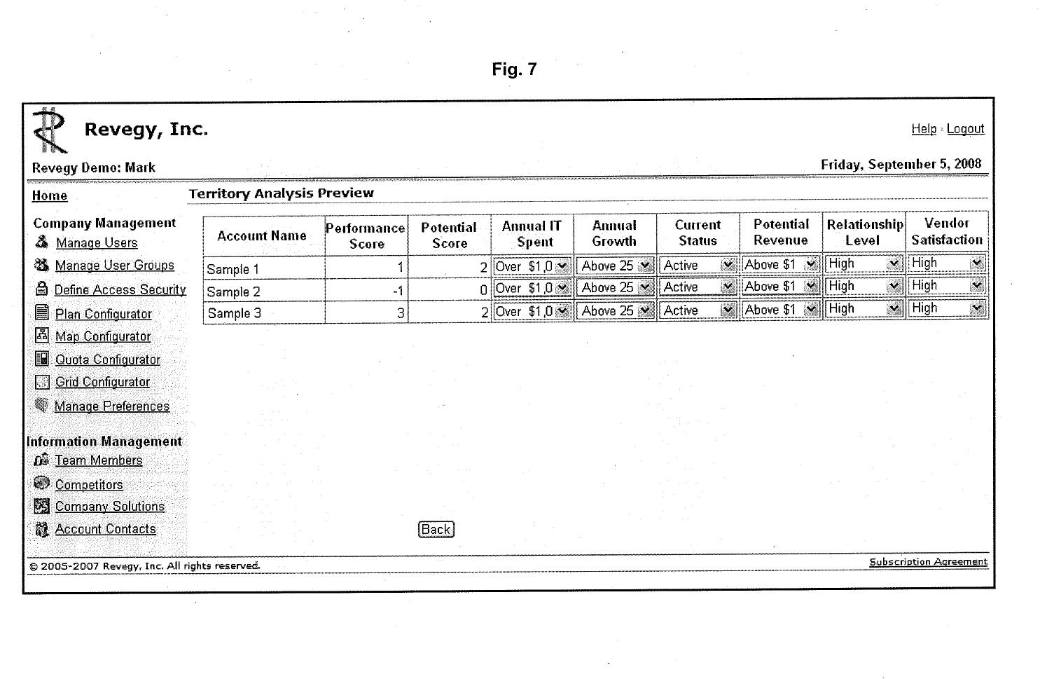

Each grid in the Grid List has Update 307, Delete 308, and Preview 309 links to respectively update, delete, or preview the grid template. The Admin can delete a grid template by selecting the Delete link 308. If the Admin selects the Update link 307, he will be presented with the Grid Detail with Axis Detail screen (FIGS. 5, 5A) for that particular grid. If the Admin selects the Preview link 309, he will be presented with the Grid Preview screen (FIG. 7).

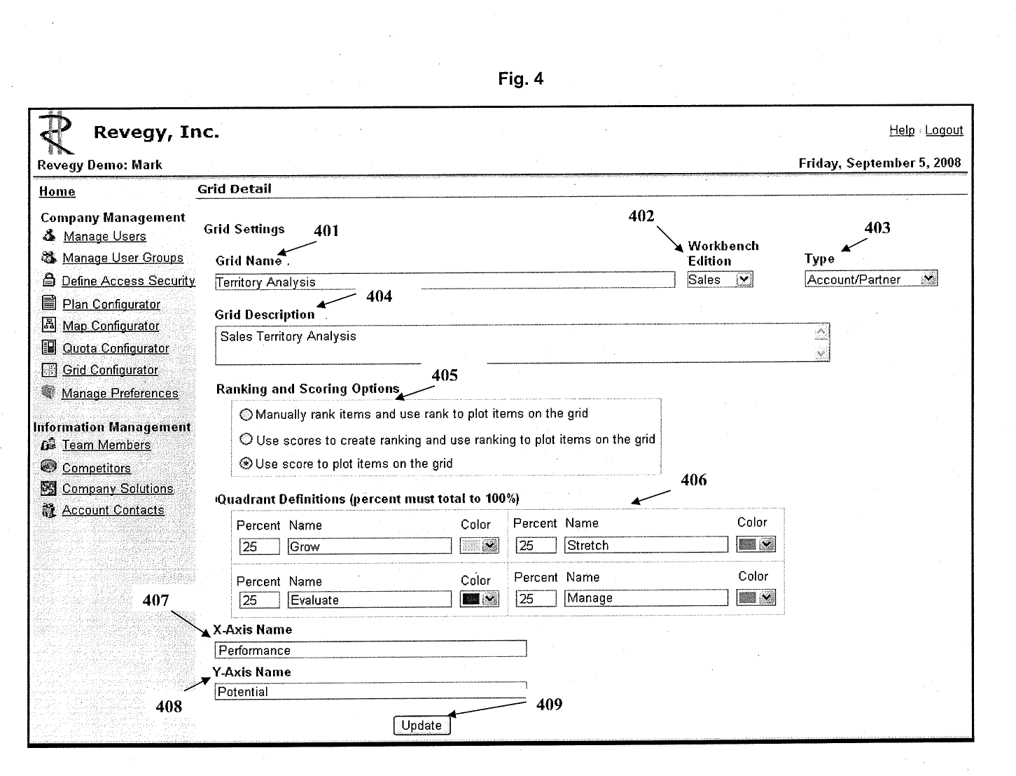

The Grid List also has an Add New Grid button 306. If the Admin selects the Add New Grid button 306, he will be taken to the Grid Detail screen (FIG. 4) where he can add a new grid template.

Turning now to the Grid Detail screen (FIG. 4), the Admin accesses this screen via the Add New Grid button 306. If the Admin selects the Update link 307 on the Grid List screen (FIG. 3), an existing Grid template is displayed on the Grid Detail with Axis Detail screen (FIGS. 5, 5A).

The Grid Detail screen (FIG. 4) has fields for Grid Name 401, Workbench Edition 402, Grid Type 403, Grid Description 404, X-Axis Name 407, and Y-Axis Name 408. The Admin can enter text (or modify existing text) in the name and description fields to give a name and description to the grid template. The Admin can also choose a selection from the Workbench Edition drop-down list 402 and from the Grid Type drop-down list 403. As described earlier, typical values for Grid Type 403 are Account/Partner or Opportunity. The Admin can name the x- and y-axes in the X-Axis Name field 407 and Y-Axis Name field 408, respectively. As described earlier, the name of the respective axes corresponds to the type of criteria that will be defined for each particular axis. For instance, naming the x-axis “Performance” indicates that the criteria for the x-axis will relate to the performance of companies. Likewise, naming the y-axis “Potential” indicates that the criteria for the y-axis will relate to the potential of companies.

The Grid Detail screen (FIG. 4) also contains fields for Rank and Scoring Options 405 and grid Quadrant Definitions 406. In the Rank and Scoring Options field 405, the Admin can select how the information will be plotted on the grid. The Admin can configure the grid template to plot companies by a manual ranking process, by an automated scoring process, or by a ranking that is based on an automated scoring process. If the Admin configures the grid template to utilize a manual ranking process, then the end-user will manually rank the various companies on the grid on a 1 to N scale. If the Admin configures the grid template for the automated scoring process, then a scoring algorithm will be utilized to calculate individual scores for each of the companies on the grid 1105 (FIG. 11). Such a score can be on a 0-100 scale, for example. If the Admin configures the grid template for a ranking based on the scoring process, then the system 110 will, after scoring each individual company, place the companies on a consecutive 1 to N ranking scale. As described more fully below, the system 110 will calculate one score (or ranking) for the x-axis to indicate the current performance of a given company and a second score (or ranking) for the y-axis to indicate the potential (future) performance of the company. The automated scoring and ranking algorithms calculate scores or rankings based on the end-user's responses to questions (grid criteria) about the company.

In the Quadrant Definitions fields 406, the Admin can name each quadrant, select a color for each quadrant, and assign a percentage to each quadrant (total percentages must equal 100).

When the Admin selects the Update button 409 (FIG. 2 step 206) on the Grid Detail screen (FIG. 4) or the Admin selects the Update link 307 on a grid row (FIG. 3), the Grid Detail with Axis Detail screen is displayed (FIGS. 5, 5A).

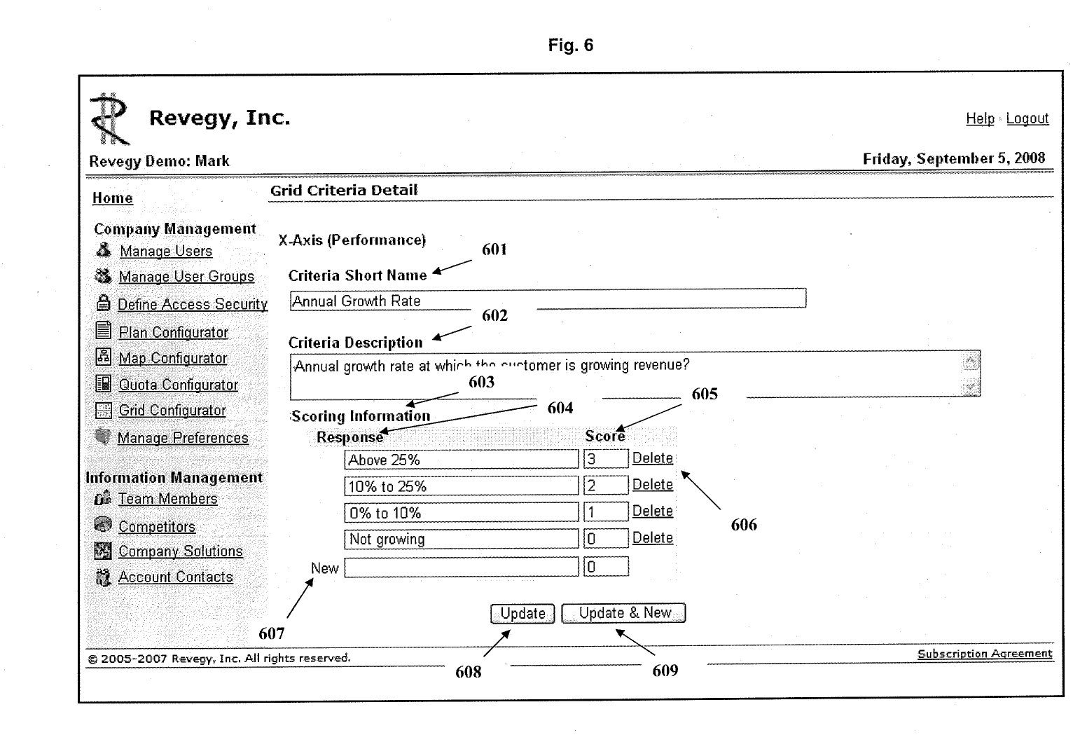

Turning to the Grid Detail with Axis Detail screen (FIGS. 5, 5A). In addition to the fields contained on the Grid Details screen (FIG. 4) and explained above, the Grid Detail with Axis Detail screen (FIGS. 5, 5A) also includes the Grid X-Axis Criteria Table 509 and the Grid Y-Axis Criteria table 510. The Admin can select the Add button 514, Update link 511, or Delete link 512. If the Admin selects the Add button 514, a blank Grid Criteria Detail screen (FIG. 6) is displayed. If the Admin selects the Update link 511, the Grid Criteria Detail screen (FIG. 6) is displayed with the corresponding grid axis criterion data. If the Admin selects the Delete link 512, the row is removed from the table.

Turning to the Grid Criteria Detail screen (FIG. 6). This screen has fields for Criteria Short Name 601, Criteria Description 602, and Scoring Information 603. Additionally, within the Scoring Information section 603 are fields for Response 604 and Score 605. As described above, the Admin will define a particular criterion (including Criteria Short Name 601, Criteria Description 602, and Response 604 and Score 605 data in the Scoring Information section 603) to relate to the criteria type (axis name). For example, if the Admin defines the x-axis as being related to the Performance criteria type by entering “Performance” in the X-Axis Name field 407, 507, then he will define his criterion on the Grid Criteria Detail screen (FIG. 6) to contain data related to a performance metric.

When the Admin enters a response into the New field 607 and selects the Update & New button 609, the response is entered into the Scoring Information table 603 and the Grid Criteria Detail screen (FIG. 6) is redisplayed. When the Admin selects Delete 606 on a particular row, that row is removed from the table. If the Admin selects Update 608, the system 110 returns the Admin to the Grid Detail with Axis Detail screen (FIGS. 5, 5A).

The data in the Scoring Information table 603 is utilized by the scoring and ranking algorithms to calculate a score or rank for a particular company based on the end-user's response to a question (criterion). For example, FIG. 6 shows the x-axis criterion detail for the Annual Growth Rate criterion. As seen in the Criteria Short Name field 601, the Admin has named this criterion as “Annual Growth Rate”. In the Scoring Information table 603, the Admin has entered four responses 604 for this criterion, namely “Above 25%”, “10% to 25%”, “0 to 10%”, and “Not growing”. The Admin has assigned scores 605 to these responses 604, respectively 3, 2, 1, and 0. As described more fully below, an end-user will respond to this “Annual Growth Rate” criterion (question) by answering whether the company under consideration is growing above 25%, between 10% and 25%, between 0% and 10%, or not at all. The scoring and ranking algorithms will use the score 605 corresponding to the end-user's chosen response 604 to calculate a score or ranking for the company.

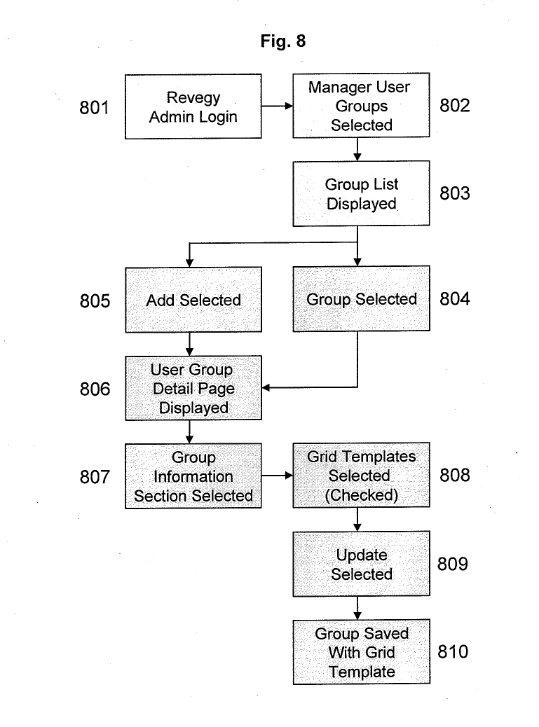

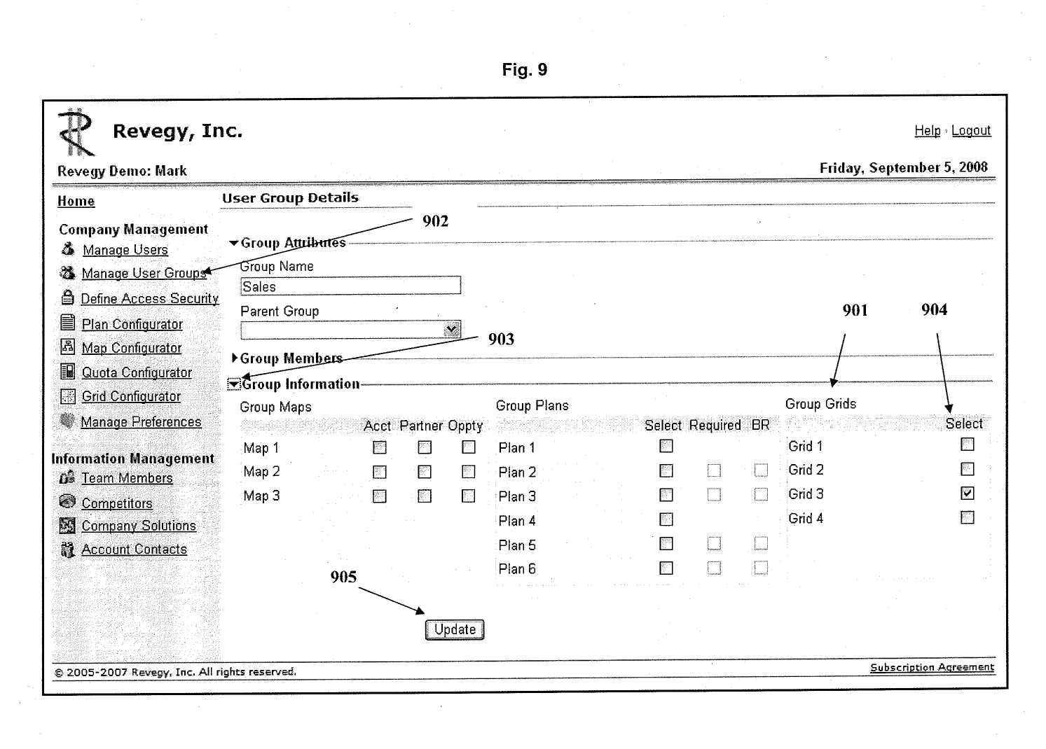

Turning now to FIGS. 8 and 9, FIG. 8 shows the steps whereby an Admin can assign a grid template to a group of end-users or a set of end-user groups. FIG. 9 shows a corresponding User Group Detail screen for a particular group. To begin, the Admin logs in at step 801 and then selects the Manage User Groups link 902 at step 802. When the Manage User Group screen (not pictured) is displayed at step 803, the Admin can add a new group (step 805) or select an existing group from a list of previously added groups (step 804). In either case the User Group Detail screen (FIG. 9) is displayed in step 806. To assign a grid template to a selected group, the Group Information section 903 is selected at step 807 and the desired grid templates 904 are checked at step 808. When all the desired grid templates 904 are selected (checked), the update button 905 is selected at step 809. Once this step is completed, members of the group can access the grid templates selected for that group.

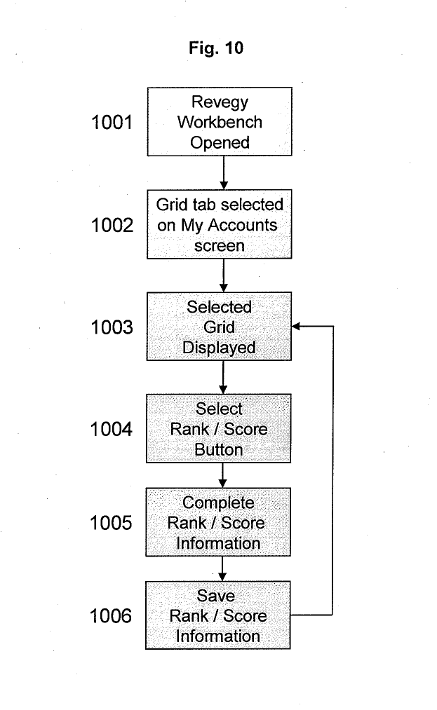

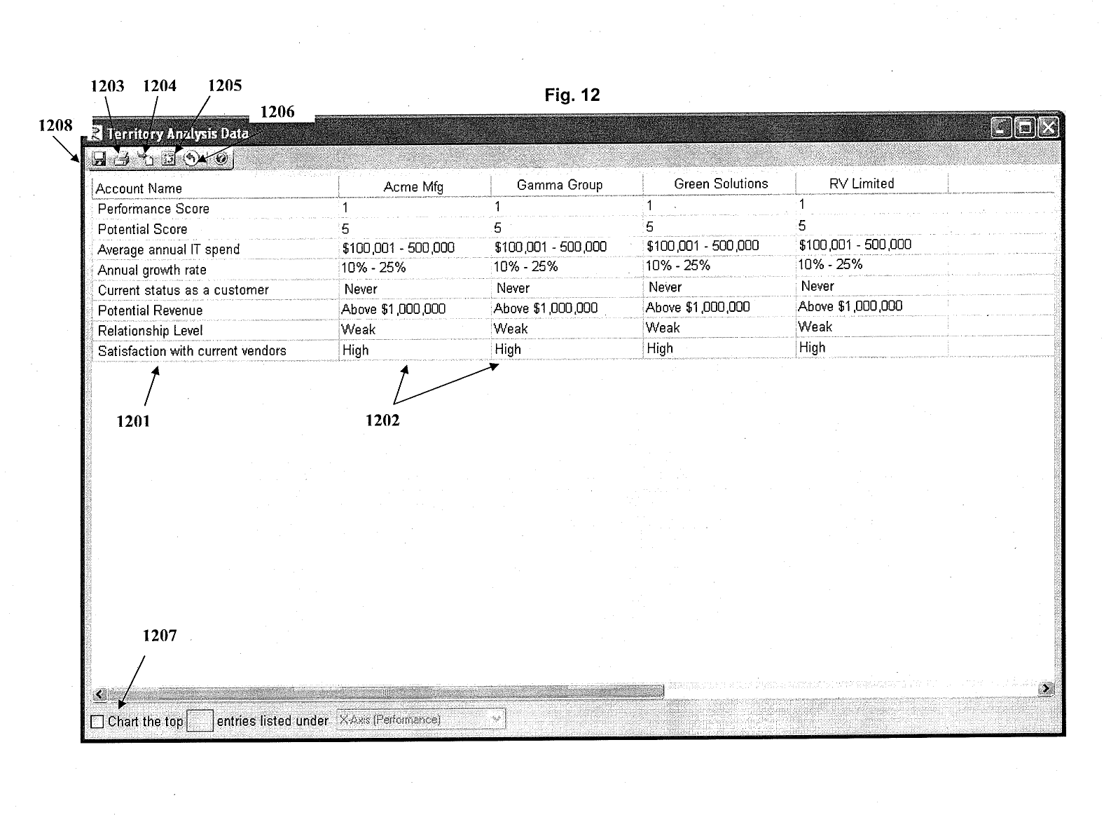

Turning now to FIG. 10, this figure shows the steps whereby an end-user can edit and utilize grids that are based on grid templates configured by an Admin in the enterprise server 101. To begin, the end-user selects a Grid Tab listed on the main workbench screen (i.e. My Accounts, My Partners, etc.) which results in the Grid screen (FIG. 11) being displayed. On this screen the end-user can view the existing grid 1105, adjust the information on the grid using the customer fields 1101, view the grid strategy legend 1102, and print the grid 1103. If the end-user would like to adjust the information on the grid, the Rank/Score button 1106 is used. When selected, the Rank/Score button 1106 results in the Grid Data screen (FIG. 12) being displayed.

On the Grid Data screen (FIG. 12), the end-user completes the answers 1202 to the questions 1201 by selecting from the drop-down lists provided in each cell. As described above in relation to FIGS. 5, 5A, and 6, the questions 1201 and answer drop-down choices 1202 are configured by an Admin who creates the grid criteria 509, 510 (FIG. 5A) and the responses 604 (FIG. 6) to the grid criteria 509. The questions 1201 are identical to the Criteria Short Name 601 (FIG. 6) for the multiple criteria on the grid. The answer drop-down choices 1202 are identical to the Responses 604 (FIG. 6) for the multiple criteria on the grid.

If there are a large number of rows on the Grid Data screen (FIG. 12), the end-user can choose to limit the number of rows plotted on the grid by specifying that only a certain number of rows be plotted in checkbox control 1207. On the Grid Data screen (FIG. 12), end-users can save the information 1208, print the information 1203, export the information 1204, swap the rows and columns 1205, or cancel all changes 1206.

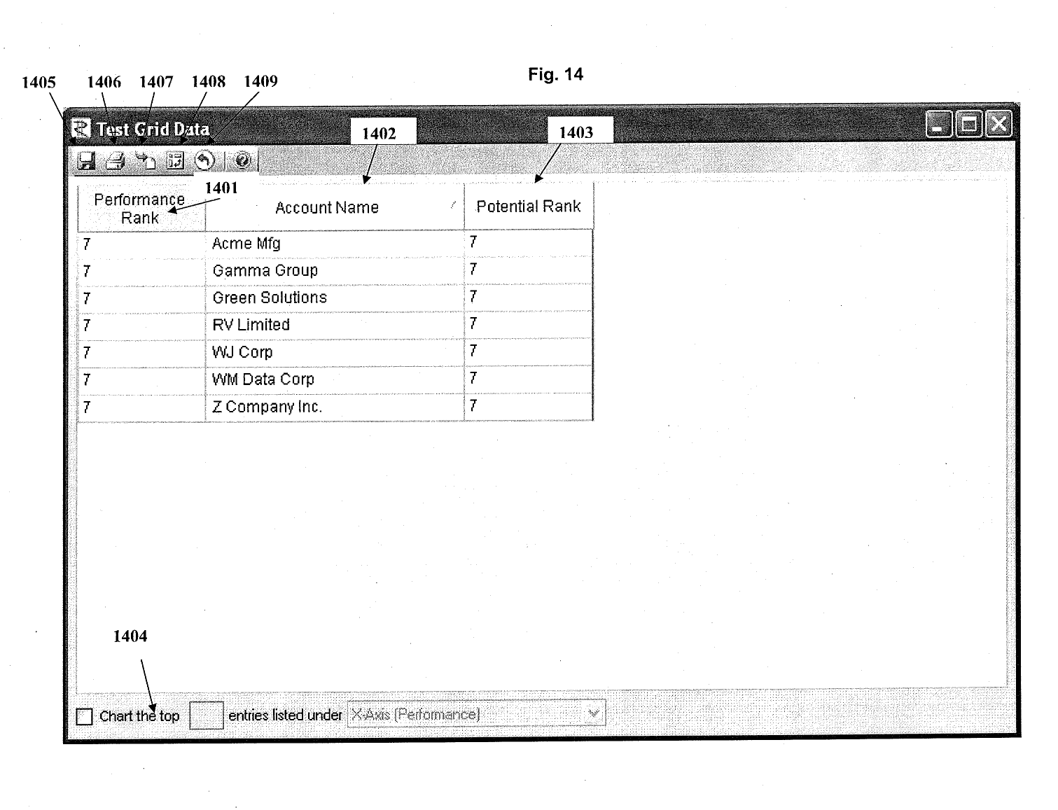

After saving information in the Grid Data screen (FIG. 12), the system 110 utilizes the appropriate algorithm to re-calculate the company's score and/or ranking. As described above in relation to the Ranking and Scoring Options 405 (FIG. 4), an Admin can configure a grid template (and all grids dependent upon that template) to plot companies by a manual ranking process, by an automated scoring process, or by an automated ranking process based on the automated scoring process. When performing the automated scoring or ranking algorithms, the system 110 utilizes the answers 1202 that the end-user provided to the questions 1201 in the Grid Data screen (FIG. 12). As described above in relation to FIG. 6, every answer 1202 in the Grid Data screen (FIG. 12) corresponds to a response 604 (FIG. 6) and a score 605 (FIG. 6). The automated scoring and ranking algorithms uses the score 605 that corresponds to the chosen answer 1202 to calculate the company's score or ranking. When performing a manual ranking process, the system 110 presents the Manual Ranking screen (FIG. 14) to the end-user, allowing him to manually enter the rankings for each company. The rankings are then used to plot the company along the x- and y-axes according to the ranking provided by the end-user.

Turning to FIG. 14, this figure shows the Manual Ranking screen that allows end-users to manually enter the x-axis (performance) ranking 1401 and the y-axis (potential) ranking 1403 for each company listed 1402. If there are a large number of rows on the Manual Ranking screen (FIG. 14), the end-user can choose to limit the number of rows plotted on the grid by specifying that only a certain number of rows be plotted in checkbox control 1404. End-users can save the information 1405, print the information 1406, export the information 1407, swap the rows and columns 1408, or cancel all changes 1409.

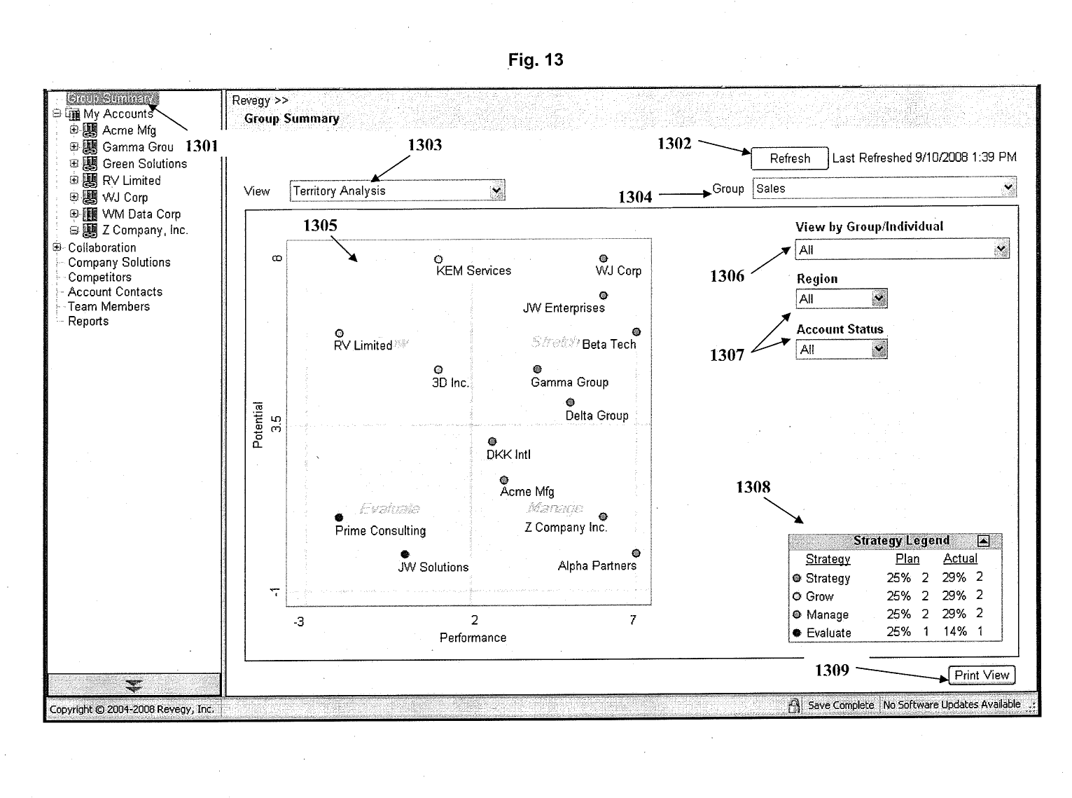

Turning now to FIG. 13, this figure shows the screen whereby an end-user group owner (manager) can view consolidated grid information that is based on grid templates configured by an Admin in the enterprise server 101 and filled in by end-users.

To begin, the group owner selects the Group Summary 1301 feature on the workbench. From here the group owner selects the Refresh button 1302 to get the latest data loaded onto the workbench. Once the refresh is completed, the group owner selects the grid from the View field 1303 and the group from the Group field 1304. The Group field 1304 displays all groups for which the individual is listed as a group owner. When the grid view is displayed, all data for the chosen group is shown on the grid 1305. The group owner can then right click on the grid 1305 to hide the names on the grid, show the names on the grid, or to view the details for all data on the grid (FIG. 12). If the group owner right clicks on a grid point, the group owner can hide the name associated with that entry on the grid or view details for that entry on the grid. FIG. 12 shows such details with four companies selected.

Group owners can also use the View by Group/Individual field 1306 or the custom fields 1307 to filter the data displayed on the grid. The custom fields 1307 shown in FIG. 13 are examples and are not intended to limit the ability to add any custom field within the system 110. Group owners can use the Print View button 1309 to print a copy of the view. Lastly, the group owners are presented the Strategy Legend 1308 which shows them the actual grid distribution versus the planned grid distribution.

Accordingly, while the system and method for configuration of revenue analysis grids has been described with reference to the structures and processes disclosed, it is not confined to the details set forth, but is intended to cover such modifications or changes as may fall within the scope of the following claims.

What is claimed is:

1. A method for configuring, maintaining, and managing analysis grid templates comprising the steps of:
a) defining a plurality of grid templates on an enterprise server;
b) defining a grid axis criteria type for each axis of each of said grid templates;
c) defining a plurality of grid axis criteria for each of said grid axis criteria types;
d) defining a plurality of responses for each of said grid axis criteria;
e) associating a score with each of said responses; and
f) displaying on a user-readable display a grid utilizing one of said grid templates for use in analyzing relationships among a plurality of companies.

2. The method of claim 1 wherein step (c) further comprises the steps of:
a) defining x-axis criteria; and
b) defining y-axis criteria.

3. The method of claim 2 further comprising the steps of:
a) defining said x-axis criteria to correspond to the current performance of a company; and
b) defining said y-axis criteria to correspond to the potential future performance of the company.

4. The method of claim 2 further comprising the steps of:
a) defining said x-axis criteria to correspond to the revenue generated from a company; and
b) defining said y-axis criteria to correspond to the risk associated with the company.

5. The method of claim 2 further comprising the steps of:
a) defining said x-axis criteria to correspond to the potential revenue associated with an Opportunity; and
b) defining said y-axis criteria to correspond to the quality of the Opportunity.

6. The method of claim 2 further comprising the steps of:
a) selecting a first response for one of said x-axis criteria;
b) selecting a second response for one of said y-axis criteria;
c) calculating in a programmable control unit a first value based on the score associated with said first response;
d) calculating in a programmable control unit a second value based on the score associated with said second response; and
e) displaying on said user-readable display a point located on said grid with said first value representing the location on the horizontal axis of said grid and said second value representing the location on the vertical axis of said grid.

7. The method of claim 2 further comprising the step of associating one of said grid templates with a group of end-users.

8. The method of claim 6 wherein an end-user utilizes said grid to perform peer-to-peer comparisons of a plurality of companies.

9. An apparatus for dynamically configuring, maintaining, and managing analysis grid templates comprising:
a) an enterprise server comprising at least one database and at least one programmable control unit to execute a program for storing grids, grid templates, grid axis criteria, responses, and scores on said database and wherein
(i) said program associates a score with each of said responses;
(ii) said program associates one or more responses with each of said grid axis criteria;
(iii) said program associates one or more grid axis criteria with each of said grid templates;
(iv) said program associates a grid with one of said grid templates; and
b) a user interface for providing input to said programmable control unit wherein an end-user may select one or more of said responses.

10. The apparatus of claim 9 wherein said grid axis criteria comprise x-axis criteria and y-axis criteria.

11. The apparatus of claim 10 wherein said x-axis criteria correspond to the current performance of a company and said y-axis criteria correspond to the potential future performance of the company.

12. The apparatus of claim 10 wherein said x-axis criteria correspond to the revenue generated from a company and said y-axis criteria correspond to the risk associated with the company.

13. The apparatus of claim 10 wherein said x-axis criteria correspond to the potential revenue associated with an Opportunity and said y-axis criteria correspond to the quality of the Opportunity.

14. The apparatus of claim 10 wherein
a) said program calculates a first value based on the score associated with a first response selected by said end-user for one of said x-axis criteria;
b) said program calculates a second value based on the score associated with a second response selected by said end-user for one of said y-axis criteria; and
c) said program displays on a display of said user interface a point located on a said grid with said first value representing the location on the horizontal axis of said grid and said second value representing the location on the vertical axis of said grid.

15. The apparatus of claim 10 wherein said program associates one of said grid templates with a group of end-users.

16. The apparatus of claim 14 wherein said end-user utilizes said grid to perform peer-to-peer comparisons of a plurality of companies.
